(19) United States
(12) Patent Application Publication
(10) Pub. No.: US 2020/0085665 A1
(43) Pub. Date: Mar. 19, 2020

(54) SPORTING APPARATUS FOR AUTOMATICALLY ADJUSTING THE CERVICAL VERTEBRAE

(71) Applicant: Young Ho CHUN, Seoul (KR)

(72) Inventor: Young Ho CHUN, Seoul (KR)

(21) Appl. No.: 16/616,277

(22) PCT Filed: Jan. 29, 2019
(86) PCT No.: PCT/KR2019/001191

§ 371 Date: Nov. 22, 2019

(30) Foreign Application Priority Data
Feb. 14, 2018 (KR) 10-2018-0018129

(51) Int. Cl. A61H 1/02; A61H 1/00

(52) U.S. Cl. CPC A61H 1/0296; A61H 39/04; A61H 1/005

(57) ABSTRACT

Provided is a sporting apparatus for automatically adjusting cervical vertebrae, which automatically moves while a user rests or sleeps with the apparatus, so as to ensure a user naturally maintains a good lying position. The sporting apparatus includes a rail assembly, a swing panel including a roller part inserted into the rail assembly to slidably move, and a support body which is coupled to and stably placed on an upper surface of the swing panel and on which a user's neck and head are stably placed. The apparatus makes an internal movement of an upper cervical vertebral portion to realign the cervical vertebrae, thereby inducing alignment and balance of the user's neck to be automatically achieved, and also inducing alignment and balance exercise of the head, a cervical vertebral portion, and an upper thoracic vertebral portion to be naturally conducted.

### TECHNICAL FIELD

The present invention relates to a sporting apparatus for automatically adjusting the cervical vertebrae, the apparatus being able to automatically operate to naturally maintain a user in a correct lying posture while the user is resting or sleeping with the apparatus.

### BACKGROUND ART

In the human body, the cervical vertebrae are portions of the spinal column above the thoracic vertebrae, and are comprised of seven bones supporting the upper body and the head. The cervical vertebrae are major portions of the human body supporting the head, the weight of which is about 10 kg, and distributing the weight of the upper body, so that the erect structure of the human body can be maintained.

Recently, cases in which modern people, e.g. not only workers but also students and housewives, suffer from neck pain are increasing, as the modern people need to watch computer monitors at a fixed position for a long time since they work using computers and the usage of smartphone has been increased.

In particular, the forward head posture (iHunch) causing neck pain is mainly caused when the posture in which the neck is leaned forward to more accurately watch a monitor or a smartphone or an action in which a smartphone or the like is worn on the neck is repeatedly continued for a long time. The forward head posture may deform not only the shape of the cervical vertebrae but also the entire body shape to be bent, thereby causing a variety of spinal column disorders, such as causing pain, cervical disc herniation, headache, and spinal column scoliosis. In addition, since the ability to sense the movement of the body may be damaged or information regarding the movement of the body may be inaccurate, so that suitable movement functions may be obstructed.

The human body is laterally symmetrical and balanced, even if the internal organs are not perfectly symmetrical. Thus, when an unbalanced posture is maintained for a long time, the balance and alignment of the spinal column, the pelvis, the neck, the shoulders, or the internal organs may be distorted. Neck pain is known to be mainly caused by a wrong posture or a wrong exercise pattern. It is reported that, specific muscles of patients suffering from neck pain are shorter or weaker than those of normal persons. In severe cases, the shape of the cervical vertebrae has the forward head posture bent forward, instead of having a normal C-shaped arc.

It is critical to prevent or suppress such a disorder by maintaining the correct posture of the cervical vertebrae. Thus, correction (or rehabilitation) exercise, such as chin-in exercise or exercise of laterally and angularly rotating the neck, intended to restore the cervical vertebrae to an original correct shape, is required. In addition, a variety of devices or apparatuses for relieving neck pain or a variety of rehabilitation devices or apparatuses for adjusting the posture of the cervical vertebrae have been developed.

However, the cervical vertebrae correcting devices or the cervical vertebrae protectors of the related art are simply configured to surround the neck to limit the movement of the cervical vertebrae. In this case, the range of movement of the cervical vertebrae is limited, and the effect of protecting the cervical vertebrae is rather insignificant, which is problematic.

To solve the foregoing problem, Korean Registered Utility Model No. 20-0483469 discloses a pillow including: a semi-cylindrical rocking panel having guide recesses in an inner surface; a semi-cylindrical pillow support body; a pillow support including a roller unit disposed on the outer surface of the pillow support body and inserted into one of the guide recesses to be slidable and a roller unit disposed on the outer surface of the pillow support body and inserted into the other one of the guide recesses to be slidable; and a pillow body seated on and coupled to the inner surface of the pillow support body and including a neck support supporting the neck of the user and a headrest on which the head of a user is seated. The pillow allows the user to take a deep sleep while reliably protecting his or her cervical vertebrae.

However, this pillow does not provide smooth sliding movement or a sufficient correction effect, since the roller units provided on the pillow support body are inserted into the guide recesses, respectively. In addition, according to the structure of the pillow, it is difficult to replace damaged components. Furthermore, the pillow is heavy. Accordingly, research on methods able to solve such drawbacks is demanded.

### DISCLOSURE

### Technical Problem

Accordingly, the present invention has been made keeping in mind the above problems occurring in the prior art, and an object of the present invention is to provide a sporting apparatus for automatically adjusting the cervical vertebrae to be able to smoothly slide to align and balance the head, cervical vertebrae, and upper thoracic vertebrae of a user while the user is resting or sleeping, so that the user can be automatically corrected to a balanced and laterally symmetrical posture. Accordingly, suitable nerve reflex control of the nerve system, the musculoskeletal system, and the internal organs may be induced.

### Technical Solution

In order to accomplish the above object, the present invention may provide a sporting apparatus for automatically adjusting the cervical vertebrae. The sporting apparatus may include: a rail assembly including a first rail having a curved structure and having a plurality of engagement holes formed in both end portions and a first guide rail recess, a second rail having a curved structure and having a plurality of engagement holes formed in both end portions and a second guide rail recess, and connecting members including one or more connecting support rods respectively having threaded engagement holes formed in both end portions thereof and being fitted into the engagement holes to couple the first rail and the second rail and fixing bolts inserted into and engaged with the engagement holes in the both end portions of the connecting support rods; a rocking panel including sliding protrusions protruding from one surface to extend in a longitudinal direction and rollers fixedly disposed on the sliding protrusions and inserted into the first guide rail recess and the second guide rail recess of the rail assembly to be slidable; and a support body seated on and coupled to a top surface of the rocking panel to seat the neck and the head of a user thereon.

According to an exemplary embodiment of the present invention, the first rail may include a first rail frame having a curved shape, the first rail frame having a plurality of engagement holes and a first guide protrusion provided on one surface and extending in a longitudinal direction, a second rail frame having a curved shape, the second rail frame having a plurality of engagement holes in positions corresponding to the engagement holes and a second guide protrusion provided on one surface and extending in a longitudinal direction, the first rail frame and the second rail frame being coupled to each other to define the first guide rail recess. The second rail may include a third rail frame having a curved shape, the third rail frame having a plurality of engagement holes and a third guide protrusion provided on one surface and extending in a longitudinal direction, and a fourth rail frame having a curved shape, the fourth rail frame having a plurality of engagement holes in positions corresponding to the engagement holes and a fourth guide protrusion provided on one surface and extending in a longitudinal direction, the third rail frame and the fourth rail frame being coupled to each other to define the second guide rail recess.

In addition, the sporting apparatus may further include buffer members surrounding and accommodating the connecting support rods.

The support body may include a neck support supporting the neck of the user and a headrest on which the head of the user is seated, with the width of the support body increasing from the neck support to the headrest.

The neck support may have a plurality of acupressure protrusions on an inner surface to press the neck of the user.

### Advantageous Effects

According to the present invention, the cervical vertebrae for automatically adjusting the cervical vertebrae can serve to correct the movement of upper the cervical vertebrae in the sporting apparatus to induce the alignment and balance of the neck to be automatically obtained and allow the alignment and balancing movement of the upper thoracic vertebrae automatically caused.

Since the rocking panel has a curved structure such as a semicircular structure, a U-shaped structure, or a C-shaped structure, the rocking panel is not dislodged from the rocking panel when the head and the neck of the user laterally rolls, so that the user can have a stable posture. A narrow linear surface portion of the rocking panel is in contact with the underlying structure, while the portion of rocking panel in contact with the head has a slightly circular shape conforming to the head to suitably press the base of the back of the head. The entire centerline of the back of the head is pressed to stimulate the cranoiosacral rhythm. A physical environment able to activate the autonomic nerve system and the central nerve system is provided. In addition, musculoskeletal recovery is enhanced.

In particular, fibers in the back of the neck enable nerve reflex when the musculoskeletal system and the internal organs have a disorder. The sporting apparatus for automatically adjusting cervical vertebrae according to the present invention can stimulate fibers in the back of the neck, thereby obtaining a suitable nerve reflex effect on the nerve system, the musculoskeletal system, and the internal organs while the user is sleeping or resting.

In addition, the support body is configured such that the width thereof increases from the neck support on which the neck of the user is seated to the headrest on which the head of the user is seated. This system structure can automatically correct the unbalanced movement of the neck and the head by the rocking panel placed below, and then, correct the movement of the upper cervical vertebrae by the rocking panel. Accordingly, the alignment and balancing of the neck can be automatically performed. The alignment and balancing of the head, cervical vertebrae, and upper thoracic vertebrae can also be automatically performed. In addition, this system can help the user easily and smoothly breathe while using the sporting apparatus.

The user can use the sporting apparatus for automatically adjusting cervical vertebrae by placing the sporting apparatus on a flat floor or on top of a bed, seating the rocking body on the rocking panel so that the headrest 330 is directed toward the head of the user, pulling the sporting apparatus so that the neck and shoulders are not spread, and smoothly placing the head on the support body 300 as if placing the head on a pillow. In this manner, the user can use comfortably rest or sleep using the sporting apparatus for automatically adjusting cervical vertebrae.

### DESCRIPTION OF DRAWINGS

FIG. 1 is an exploded perspective view illustrating a sporting apparatus for automatically adjusting cervical vertebrae 10 according to an exemplary embodiment of the present invention;

FIGS. 2A and 2B are top and side views illustrating the support body according to an embodiment of the present invention; and

FIG. 3 is an exploded perspective view illustrating a sporting apparatus for automatically adjusting cervical vertebrae 10′ including the rail assembly 100′ according to an exemplary embodiment of the present invention.

### BEST MODE

Hereinafter, exemplary embodiments of the present invention will be described in detail with reference to the accompanying drawings.

Embodiments of the present invention are disclosed to more fully convey the present invention to those skilled in the art to which the present invention relates. The present invention may be embodied in many different forms and should not be construed as being limited to the embodiments set forth herein. Rather, these embodiments are provided so that the present disclosure is more thorough and complete and will fully convey the idea of the present invention to those skilled in the art.

The terminologies used herein are for the purpose of describing particular embodiments only and are not intended to be limiting. As used herein, singular forms are intended to include plural forms as well, unless the context clearly indicates otherwise. In addition, the terms “comprise” and variations thereof, when used in this specification, specify the presence of stated features, numbers, steps, operations, members, elements, and/or groups but do not preclude the presence or addition of one or more other features, numbers, steps, operations, members, elements, and/or groups. The term “and/or” used herein includes any or at least one or at least one combination of mentioned items.

It will be understood that, although the terms, such as “first” and “second”, may be used herein to describe various members, areas, and/or portions, these members, areas, layers, and/or portions should not be limited by these terms. These terms are not used to indicate a specific sequence, order, or superiority and inferiority but only used to distinguish one member, area, or portion from another member, area, or portion. Accordingly, a first member, area, or portion may be used to refer to a second member, area, or portion without departing from the scope of the present invention.

Hereinafter, embodiments of the present invention will be described in conjunction with the accompanying drawings schematically illustrating the embodiments. In the drawings, for example, the illustrated features may be modified, depending on the manufacturing technique and/or tolerance. Accordingly, embodiments of the present invention should not be interpreted to be limited to specific features illustrated, but may include variations of the features, for example, caused in the manufacturing process.

A sporting apparatus for automatically adjusting the cervical vertebrae according to the present invention is designed to automatically maintain a user in a laterally-balanced posture to directly face upward while resting or sleeping. Thus, when the user, lying while wearing the sporting apparatus, unconsciously turns over due to pressure and inconvenience, a rocking panel and a supporting base can simultaneously and automatically move to maintain the balance of the neck and align the posture of the user.

Consequently, when the sporting apparatus for automatically adjusting the cervical vertebrae according to the present invention is used, the user can naturally maintain a correct lying posture. When the sporting apparatus is used for a long time, the user can develop a habit of sleeping in a correct lying posture.

In particular, the sporting apparatus for automatically adjusting the cervical vertebrae according to the present invention is advantageously intended to overcome the drawbacks of the pillow according to Korean Registered Utility Model No. 20-0483469. That is, a rail assembly is provided to form a structure able to smoothly slide when a user moves his or her body while resting or sleeping. A variety of components of the rail assembly are provided as modules in order to facilitate the replacement of components and reduce the weight of the apparatus.

Hereinafter, the present invention will be described in detail.

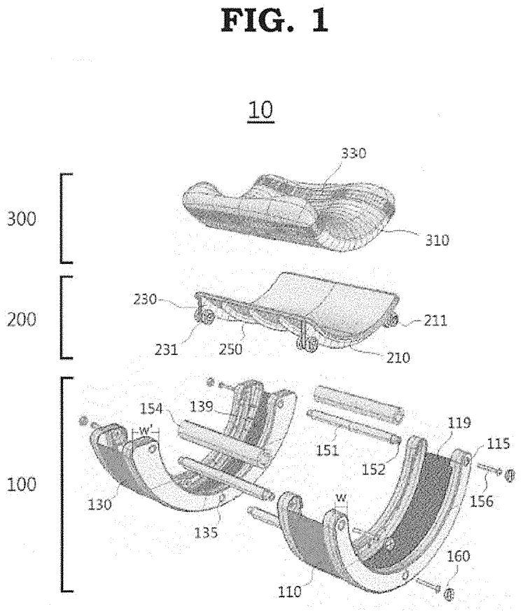

FIG. 1 is an exploded perspective view illustrating a sporting apparatus for automatically adjusting the cervical vertebrae 10 according to an exemplary embodiment of the present invention.

Referring to FIG. 1, the sporting apparatus for automatically adjusting the cervical vertebrae 10 according to the present invention includes a rail assembly 100, a rocking panel 200, and a support body 300.

The rail assembly 100 includes a plurality of components, such as a first rail 110, a second rail 130, and connecting members 150. The rail assembly 100 has a modular structure provided by assembling these components.

Specifically, the first rail 110 has a curved structure, such as a semicircular structure, a U-shaped structure, or a C-shaped structure. The first rail 110 has a plurality of engagement holes 115 formed in both end portions thereof and a first guide rail recess 119 formed on one surface thereof.

In addition, the second rail 130 has a structure corresponding to the first rail 110, with a plurality of engagement holes 135 being formed in both end portions thereof and a first guide rail recess 139 formed on one surface thereof. The second rail 130 may be coupled to the above-described first rail 110 to form a track along which the rocking panel 200 and the support body 300, which will be described later, slide at a predetermined angle.

Here, the first rail 110 and the second rail 130 may be implemented as integral frame members having curved structures in which the first guide rail recess 119 and the second guide rail recess 139 are provided on predetermined surfaces thereof, respectively. Specifically, the first rail 110 and the second rail 130 may be implemented as integral frame members, respectively.

The first rail 110 and the second rail 130 may be coupled to each other using the connecting members 150, thereby constituting the rail assembly 100. The connecting members 150 include a plurality of connecting support rods 151 and a plurality of fixing bolts 156.

Specifically, each of the connecting support rods 151 is a rod-shaped structure, with threaded engagement holes 152 being formed in both end portions thereof. The connecting support rods 151 may be inserted into the engagement holes 115 and 135 of the first rail 110 and the second rail 130 to provide a structure by which the first rail 110 and the second rail 130 are coupled to each other. The fixing bolts 156 are engaged with the engagement holes 152 provided in the both end portions of the connecting support rods 151 to couple the first rail 110 and the second rail 130, thereby constituting the rail assembly 100. The connecting support rods 151 may be provided as two or more connecting support rods 151 in order to constitute the rail assembly 100.

According to an exemplary embodiment of the present invention, each of the first rail 110 and the second rail 130 may have a structure in which three pairs of engagement holes 115 and 135 are provided. Specifically, a pair of engagement hole 115 may be formed in a central portion of the first rail 110, in addition to the engagement holes 115 formed in the both end portions of the first rail 110. In addition, a pair of engagement hole 135 may be formed in a central portion of the second rail 130, in addition to the engagement holes 135 formed in the both end portions of the second rail 130. Accordingly, this configuration allows the connecting support rods 151 to be fitted into the engagement holes 115 and 135, thereby constituting the rail assembly 100.

The rail assembly 100 constituted by fitting the first rail 110 and the second rail 130 using the connecting members 150 as described above has a structure in which rollers 211 and 231 of the rocking panel, which will be described later, are mounted on the first guide rail recess 119 of the first rail 110 and the second guide rail recess 139 of the second rail 130. This structure of the rail assembly allows smooth sliding movement in response to movement of the user resting or sleeping. In addition, a variety of components of the rail assembly 100 can be provided as modules to advantageously facilitate the replacement of components, and the sporting device can be advantageously designed to be lightweight.

The first rail 110, the second rail 130, and the connecting members 150 of the rail assembly 100 may be formed of a high strength plastic, such as fiber reinforced plastic or reinforced plastic; a lightweight metal alloy, such as an aluminum alloy or a magnesium alloy; a metal alloy; or the like. Specifically, the first rail 110 and the second rail 130 may be made of a reinforced plastic, and the connecting members 150 may be made of a lightweight aluminum alloy or the like, so that the weight of the sporting apparatus 10 can be reduced.

In particular, buffer members 154 may further be provided. Each of the buffer members 154 may accommodate a corresponding one of the connecting support rods 151 while surrounding the outer circumferential surface of the corresponding connecting support rod 151. The buffer members 154 may be manufactured from a material having superior elasticity, such as styrene butadiene rubber (SBR), natural rubber (NR), or ethylene propylene rubber (EPDM).

The rocking panel 200 of the sporting apparatus for automatically adjusting the cervical vertebrae 10 according to the present invention is a plate member having a curved structure slidably coupled to the rail assembly 100. The rocking panel 200 may provide a structure able to automatically smoothly slide when the head or the neck moves. The rocking panel 200 may have curved structure, such as a semicircular structure, a U-shaped structure, or a C-shaped structure, to be coupled to the rail assembly 100. The rocking panel 200 includes a first sliding protrusion 210 and a second sliding protrusion 230 protruding from one surface to extend in a longitudinal direction and two or more rollers 211 and 231 fixed to the first and second sliding protrusions 210 and 220 and inserted into the first guide rail recess 119 and the second guide rail recess 139 of the rail assembly 100 so as to be slidably movable.

The rollers 211 and 231 serve to provide driving power such that the rocking panel 200 mounted on the rail assembly 100 moves in both directions within a predetermined angle range. When the user, lying with the sporting apparatus for automatically adjusting the cervical vertebrae 10 worn on the user, unconsciously turns over due to pressure and inconvenience, the rocking panel 200 can simultaneously and automatically move to maintain the balance of the neck. Accordingly, the user can be automatically maintained in the laterally-balanced posture of directly facing upward.

In this regard, the rollers 211 and 231 may be provided as a plurality of rollers on the sliding protrusions 210 and 230 to form a structure allowing the rocking panel 200 of the rail assembly 100 to easily slide. Each of the sliding protrusions 210 and 230 may be provided with two or more rollers to allow sliding movement. Specifically, each of the rollers 211 and 231 may be two or more rollers provided on both portions of each of the sliding protrusions 210 and 230.

The rocking panel 200 may have a structure further including one or more support protrusions 250, in addition to the sliding protrusions 210 and 230, to induce strength so that the rocking panel 200 can sufficiently support the head.

Furthermore, the rocking panel 200 may be formed of a high strength plastic, such as fiber reinforced plastic or reinforced plastic; a lightweight metal alloy, such as an aluminum alloy or a magnesium alloy; a common metal alloy; or the like. Specifically, the rocking panel 200 may be made of a reinforced plastic to ensure that the sporting apparatus 10 has reduced weight and high strength.

The support body 300 of the sporting apparatus for automatically adjusting the cervical vertebrae 10 according to the present invention is seated on and coupled to the top surface of the rocking panel 200. The support body 300 can serve to provide a space in which the neck and the head of the user are seated, stably support a portion of the cervical vertebrae that does not touch a surface when the user is in a lying posture or is sleeping to protect the cervical vertebrae, and allow the user maintain a straight posture to have a comfortable sleep.

The support body 300 may have a variety of configurations so as to be mounted on the top surface of the rocking panel 200. That is, the support body 300 may have a curved structure, such as a semicircular structure, a U-shaped structure, or a C-shaped structure, to surround and accommodate the outer circumferential surfaces of the neck and the head of the user. Specifically, the support body 300 may have a structure including a neck support 310 to support the neck of the user and a headrest 330 on which the head of the user is seated.

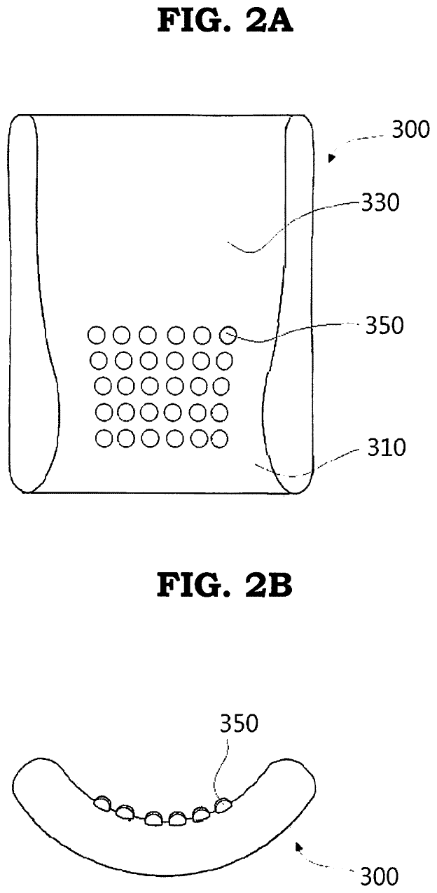

In addition, FIGS. 2A and 2B are top and side views illustrating the support body according to an embodiment of the present invention.

Referring to FIGS. 1 and 2A, the neck support 310 of the support body 300 according to an exemplary embodiment of the present invention may have a structure corresponding to the shape of the cervical vertebrae such that a central portion thereof is bulged to be convex so that the neck can be seated on the central portion. Due to this structure, the neck support 310 can more stably support the cervical vertebrae. Both edge portions of the neck support 310 may have a bulged and curved structure to stably support the neck portion of the user in order to reduce the fatigue of the neck portion.

In addition, the headrest 330 has a structure in which a top portion and edge portions upwardly protrude bulged compared to the other portions to surround the entire side portions of the head, thereby having a structure able to be stable when the user is sleeping or resting.

In addition, referring to FIGS. 2A and 2B, the neck support 310 of support body 300 is provided with a plurality of acupressure protrusions 350 on the inner surface of thereof. When the apparatus is worn, specific portions of the neck of the user can be pressed, thereby inducing an acupressure effect. The acupressure protrusions 350 may have a cylindrical or hemispherical structure, the diameter of the cross-section of which ranges from 0.5 cm to 2.0 cm, in order to improve the acupressure effect.

In addition, the support body 300 may be manufactured from polypropylene, polyurethane, latex, open cell silicon, or the like. Specifically, the support body 300 may be manufactured from open cell silicon, in considerable of the ability of the support body 300 to efficiently dissipate heat from the user and retain the shape thereof for a long time.

For reference, the open cell silicon is a type of silicon having a great number of voids. The open cell silicon provides a degree of hardness that does not change over time, and has stable and semi-permanent physical properties, so that the height or angle of the support body may be maintained when the user uses the support body. In addition, since a great number of voids is formed in the surface, heat generated from the head can be rapidly dissipated and a ventilating function can be provided so that the head can be constantly maintained to be cool. In addition, it is possible to prevent pressure applied to the head or the neck from being applied to nerves, muscles, or veins and prevent from heat being concentrated in the head.

Alternatively, the support body 300 may be implemented as an air cushion in which air is injected. The air cushion of the support body 300 may be divided into two sections, i.e. the neck support 310 and the headrest 330, such that air trapped in one section does not communicate with air trapped in the other section. When a greater pressure is applied to the neck of the user, an effect of pulling the chin may be induced, thereby preventing air from moving toward the head by the pressure applied to the neck.

In addition, a rail assembly 100′ according to an exemplary embodiment of the present invention may have a structure in which the entire components thereof are manufactured as modules, so that the components can be more easily replaced.

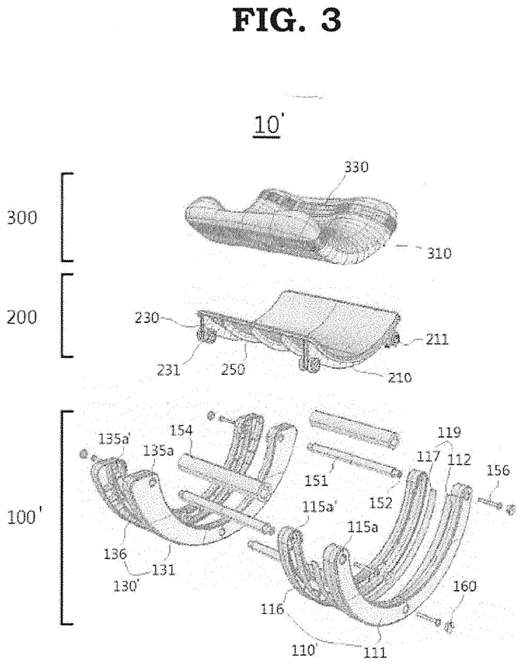

FIG. 3 is an exploded perspective view illustrating a sporting apparatus for automatically adjusting the cervical vertebrae 10′ including the rail assembly 100′ according to an exemplary embodiment of the present invention.

Referring to FIG. 3, a first rail 110′ includes a first rail frame 111 having a curved shape and a second rail frame 116 having a curved shape. The first rail frame 111 has a plurality of engagement holes 115a, and has a first guide protrusion 112 provided on one surface and extending in a longitudinal direction. The second rail frame 116 has a plurality of engagement holes 115a′ in positions corresponding to the engagement holes 115a, and has a second guide protrusion 117 provided on one surface and extending in a longitudinal direction. The first rail frame 111 and the second rail frame 116 may be coupled to each other to provide the first rail 110′ having the first guide rail recess 119 having an inwardly depressed structure.

In addition, a second rail 130′ may have the same structure as the first rail 110′. The second rail 130′ may include a third rail frame 131 having a curved shape and a fourth rail frame 136 having a curved shape. The third rail frame 131 has a plurality of engagement holes 135a, and has a third guide protrusion (not shown) provided on one surface and extending in a longitudinal direction. The fourth rail frame 136 has a plurality of engagement holes 135a′ in positions corresponding to the engagement holes 135a′, and has a fourth guide protrusion (not shown) provided on one surface and extending in a longitudinal direction. The third rail frame 131 and the fourth rail frame 136 may be coupled to each other to provide the second rail 130′ having the second guide rail recess 139.

In addition, when the first rail 110′ and the second rail 130′ are provided by coupling the rail frames 111, 116, 131, and 136 using the connecting members 150, the first to fourth guide protrusions 112 and 117 may be further provided with fitting projections (not shown), respectively. This may provide a structure for preventing the rollers 211 and 231 of the rocking panel 200, which will be described later, from being dislodged from the rail assembly 100′.

The rail assembly 100′ may be coupled to the rocking panel 200 and the support body 300 having the same structures as those of the foregoing embodiment, thereby constituting the sporting apparatus for automatically adjusting the cervical vertebrae 10.

Furthermore, in the rail assembly 100 according to the present invention, the width W of the integral frame member of the first rail 110 may be different from the width W′ of the integral frame member of the second rail 130, such that the length of a track on which the neck support 310 moves is longer than length of a track on which the headrest 330 moves. Due to this configuration, when the posture of the user is significantly changed, the headrest 330 may insignificantly move although the neck support 310 moves significantly. Accordingly, a balanced posture may be induced to the user, thereby further improving the function of automatically moving and adjusting the cervical vertebrae.

In addition, according to an exemplary embodiment of the present invention, the first rail 110′ including the first rail frame 111 and the second rail frame 116 and the second rail 130′ having the third rail frame 131 and the fourth rail frame 136 may be configured such that the widths thereof are set to be the same as described above, so that the same effect can be obtained.

In the sporting apparatus for automatically adjusting the cervical vertebrae 10 according to the present invention as described above, the rollers 211 and 231 of the rocking panel may be mounted to the first guide rail recess 119 and the second guide rail recess 139 of the rail assembly 100 to provide a slidable structure, and the support body 300 may be mounted to the top portion of the rocking panel 200 to provide a structure for stably supporting the neck and the head of the user.

In the above-described assembled state, when the user laterally moves the body, for example, rolls while lying or sleeping using the sporting apparatus for automatically adjusting the cervical vertebrae 10, the rocking panel 200 and the support body 300 seated on the rail assembly 100 can slide on the rail assembly 200 to ensure that the user can deeply sleep while stably protecting his or her cervical vertebrae, differently from conventional pillows having a flat surface.

Here, since the support body 300 is in close contact with the body using the structure for stably supporting the neck and the head of the user, the head is not separated from the support body even in the case in which the rocking panel laterally moves, so that the user can maintain a stable sleeping posture.

Furthermore, the sporting apparatus for automatically adjusting the cervical vertebrae 10 according to the present invention may further include protection caps 160 attached to the engagement holes 115 and 135 to protect the connecting support rods 151 and the fixing bolts 156. The protection caps 160 may be manufactured from a material having superior elasticity, such as styrene butadiene rubber (SBR), natural rubber (NR), or ethylene propylene rubber (EPDM).

The sporting apparatus for automatically adjusting the cervical vertebrae 10 according to the present invention as described above is completed by slidably fitting the rollers 211 and 231 of the rocking panel into the first guide rail recess 119 and the second guide rail recess 139 of the rail assembly 100 having a semicircular structure, a U-shaped structure, or a C-shaped structure and coupling the support body 300 to the rocking panel 200 such that the support body 300 is seated on the top surface of the rocking panel 200.

A user resting or sleeping in a lying posture using a typical pillow may turn over when a pressure or inconvenience is felt. In this process, the neck and the head may also move to align the skull into a conformable posture. In this case, generally, the neck may be unbalanced and misaligned. When this posture is maintained for a long time, the cervical vertebrae and the muscles may be tensed or stress, which is problematic.

However, when the user rests or sleeps with his or her head on the sporting apparatus for automatically adjusting the cervical vertebrae according to the present invention, the sporting apparatus can align the user to maintain a laterally symmetrical lying posture while straightly facing upward and alight the balance of the neck, thereby naturally maintain a correct lying posture. Accordingly, when the sporting apparatus is used for a long time, the user can develop a habit of sleeping in a correct lying posture.

In addition, the sporting apparatus for automatically adjusting the cervical vertebrae 10 can serve to correct the movement of upper the cervical vertebrae in the sporting apparatus to induce the alignment and balance of the neck to be automatically obtained and allow the alignment and balancing movement of the upper thoracic vertebrae automatically caused.

Since the rocking panel 200 has a curved structure such as a semicircular structure, a U-shaped structure, or a C-shaped structure, the rocking panel 200 is not dislodged from the rocking panel when the head and the neck of the user laterally rolls, so that the user can have a stable posture. A narrow linear surface portion of the rocking panel 200 is in contact with the underlying structure, while the portion of rocking panel 200 in contact with the head has a slightly circular shape conforming to the head to suitably press the base of the back of the head. The entire centerline of the back of the head is pressed to stimulate the cranoiosacral rhythm. A physical environment able to activate the autonomic nerve system and the central nerve system is provided. In addition, musculoskeletal recovery is enhanced.

In particular, fibers in the back of the neck enable nerve reflex when the musculoskeletal system and the internal organs have a disorder. The sporting apparatus for automatically adjusting cervical vertebrae according to the present invention can stimulate fibers in the back of the neck, thereby obtaining a suitable nerve reflex effect on the nerve system, the musculoskeletal system, and the internal organs while the user is sleeping or resting.

In addition, the support body 300 is configured such that the width thereof increases from the neck support 310 on which the neck of the user is seated to the headrest 330 on which the head of the user is seated. This system structure can automatically correct the unbalanced movement of the neck and the head by the rocking panel 200 placed below, and then, correct the movement of the upper cervical vertebrae by the rocking panel 200. Accordingly, the alignment and balancing of the neck can be automatically performed. The alignment and balancing of the head, cervical vertebrae, and upper thoracic vertebrae can also be automatically performed. In addition, this system can help the user easily and smoothly breathe while using the sporting apparatus.

The user can use the sporting apparatus for automatically adjusting cervical vertebrae 10 by placing the sporting apparatus on a flat floor or on top of a bed, seating the rocking body on the rocking panel 200 so that the headrest 330 is directed toward the head of the user, pulling the sporting apparatus so that the neck and shoulders are not spread, and smoothly placing the head on the support body 300 as if placing the head on a pillow. In this manner, the user can use comfortably rest or sleep using the sporting apparatus for automatically adjusting cervical vertebrae 10.

Hereinafter, the present invention will be described in more detail with respect to following examples.

Proposed examples shall be interpreted as being specific illustrations of the present invention while not being limitative of the scope of the present invention.

### Examples

Body dynamics research was undertaken in order to analyze the effects of the sporting apparatus for automatically adjusting the cervical vertebrae as illustrated in FIG. 3.

(1) Selection of Users

In order analyze the effects of the sporting apparatus for automatically adjusting the cervical vertebrae, body dynamics research was undertaken by selecting eight (8) male persons in their twenties having good health conditions without musculoskeletal disorders related to the waist. All of the users were selected to be right handed in order to minimize experimental errors. Measurements taken from the bodies of the users are represented in Table below 1.

TABLE 1

| | | Standard |
|---|---|---|
| | Mean | deviation |
| Age | 27.4 | 1.2 |
| Height (cm) | 175.3 | 3.1 |
| Weight (kg) | 67.3 | 7.1 |

(2) Analysis of Neck Posture

In order to analyze effects induced from the use of the sporting apparatuses for automatically adjusting the cervical vertebrae, changes in the neck posture of the users occurring during sleeping were analyzed. Here, typical pillows and memory form pillows commercially distributed were used as control groups.

In order to analyze the neck posture, all of the eight users were comfortably dressed, reference points (e.g. targuses, shoulder points, an occiput point, and a posterior neck (point)) necessary for the measurement of changes in the neck posture were marked, electrode attachment points were sterilized with alcohol (alcohol preparation), and surface electrodes (6-channel surface electrodes) were attached to the attachment points.

After the reference points necessary for the measurement of changes in the neck posture were marked, the users were directed to stand up before images were captured from the users. The users were directed to have their most comfortable postures while lying on the sporting apparatus or the pillow. Images of the neck postures of the users lying in their most comfortable postures were captured. In order to reduce photographing errors, a camera was fixed to a tripod so that the position of the camera did not move.

For reference, an important factor of the sporting apparatus for automatically adjusting the cervical vertebrae according to the present invention or a pillow is to maintain the neck in a posture that the neck would naturally take when the user is standing. Maintaining the posture of the neck in the natural posture means that seven the cervical vertebrae are correctly aligned in a centerline so that the cervical vertebrae are curved (cervical curvature). However, when the cervical vertebrae significantly misaligned from the centerline instead of being correctly aligned, shear force occurs in the opposite direction to the misalignment, so that the curvature of the cervical vertebrae is distorted. Here, shear forces are parallel forces acting in opposite directions with respect to a specific surface of an object. When an unsuitable pillow is used, the curvature of the cervical vertebrae may be distorted, and shear force occurs in the direction opposite to the distortion. When shear forces occur, the cervical vertebrae may be unstable. Accordingly, the cervical vertebrae may be regarded as being stable when the angle of the neck is close to 0°.

The users were directed to sleep for three hours according to the above-described conditions, and changes in the angle of the neck in the straightly laying posture were measured in mean values. Results are represented in Table 2 below.

TABLE 2

| | Sporting | Typical | Memory form |
|---|---|---|---|
| | apparatus¹⁾ | pillow | pillow |
| Change in neck angle | 6.192 | 22.135 | 17.352 |

As represented in Table 2, it can be appreciated that changes in the angle of the neck, measured from the users directed to sleep using the sporting apparatus for automatically adjusting the cervical vertebrae, are significantly smaller than those measured from the users directed to sleep using the typical pillow or the memory form pillow.

According to this result, it was determined that, when the user slept using the sporting apparatus for automatically adjusting the cervical vertebrae according to the present invention, the user body could maintain the most natural posture, since the posture was automatically aligned to maintain the correct lying posture and the balance of the neck was retained even when the posture was changed.

(3) Measurement of Body Pressure Distribution

In order to measure the degree of uniform distribution of body pressure when the users lie with the heads on the sporting apparatus for automatically adjusting the cervical vertebrae, pressures applied to the head surfaces were measured using sensors. Pressure measurement points were two points (S1, S2) adjoining the occiput point, two points (S3, S4) parallel with respect to the inion, Semispinal scapitis M. (S5), two points (S6, S7) with respect to phantom lines parallel to euryons. In order to reduce measurement errors, the measurement was performed by fixing the sensors to thin cloth wrapped on the head, instead of directly fixing the sensors to the surface of the head.

For reference, a high body pressure occurring in a specific portion indicates that the sporting apparatus for automatically adjusting the cervical vertebrae or the pillow failed to distribute the weight of the head and the pressure was localized. When such localized pressure is maintained, pain may be caused in the pressed point.

In the measurement of muscle activity, body pressures g/cm³ were measured from the surfaces of the head in order to determine the degree of muscle activity and the degree of distribution of body pressure in the surface of the head in the correct lying posture using the sporting apparatus or the pillow. Results are represented in Table 3 below.

TABLE 3

| | | Sporting | Typical | Memory form |
|---|---|---|---|---|
| | | apparatus¹⁾ | pillow | pillow |
| Body | S1 | 14.7 | 22.1 | 25.1 |
| pressure | S2 | 15.4 | 27.1 | 31.2 |
| | S3 | 9.7 | 5.6 | 6.1 |
| | S4 | 9.8 | 5.9 | 6.2 |
| | S5 | 18.6 | 24.7 | 25.5 |
| | S6 | 8.7 | 6.3 | 4.7 |
| | S7 | 9.1 | 6.7 | 4.9 |

Note:
¹⁾Sporting apparatus for automatically adjusting the cervical vertebrae

As represented in Table 3, it can be appreciated that pressure was applied to the occiput point and the inion in the typical pillow, the memory form pillow, and the sporting apparatus. It was determined that, when the memory form pillow was used, pressure was concentrated to a specific portion, e.g. the occiput point, such that the pressure was higher than when the sporting apparatus or the typical pillow was used.

However, it can be appreciated that, when the sporting apparatus according to the present invention was used, the body pressures in the surface of the head were more uniformly distributed than when the typical pillow or the memory form pillow was used.

In addition, it can be appreciated that, when the user turned the body while sleeping, the sporting apparatus for automatically adjusting the cervical vertebrae according to the present invention maintained a suitable shape to support the entire portions of the head so that body pressure was not concentrated to a specific portion and was uniformly distributed. In contrast, it can be appreciated that, when the typical pillow or the memory form pillow was used, body pressure was concentrated to a specific portion.

### DESCRIPTION OF THE REFERENCE NUMERALS IN THE DRAWINGS

10: sporting apparatus for automatically adjusting the cervical vertebrae
100: rail assembly
200: rocking panel
300: backing body

1. A sporting apparatus for automatically adjusting the cervical vertebrae, the sporting apparatus comprising:
a rail assembly including a first rail having a curved structure and having a plurality of engagement holes formed in both end portions and a first guide rail recess, a second rail having a curved structure and having a plurality of engagement holes formed in both end portions and a second guide rail recess, and connecting members including one or more connecting support rods respectively having threaded engagement holes formed in both end portions thereof and being fitted into the engagement holes to couple the first rail and the second rail and fixing bolts inserted into and engaged with the engagement holes in the both end portions of the connecting support rods;
a rocking panel including sliding protrusions protruding from one surface to extend in a longitudinal direction and rollers fixedly disposed on the sliding protrusions and inserted into the first guide rail recess and the second guide rail recess of the rail assembly to be slidable; and
a support body seated on and coupled to a top surface of the rocking panel to seat the neck and the head of a user thereon.

2. The sporting apparatus according to claim 1, wherein the first rail includes a first rail frame having a curved shape, the first rail frame having a plurality of engagement holes and a first guide protrusion provided on one surface and extending in a longitudinal direction, a second rail frame having a curved shape, the second rail frame having a plurality of engagement holes in positions corresponding to the engagement holes and a second guide protrusion provided on one surface and extending in a longitudinal direction, the first rail frame and the second rail frame being coupled to each other to define the first guide rail recess, and
the second rail includes a third rail frame having a curved shape, the third rail frame having a plurality of engagement holes and a third guide protrusion provided on one surface and extending in a longitudinal direction, and a fourth rail frame having a curved shape, the fourth rail frame having a plurality of engagement holes in positions corresponding to the engagement holes and a fourth guide protrusion provided on one surface and extending in a longitudinal direction, the third rail frame and the fourth rail frame being coupled to each other to define the second guide rail recess.

3. The sporting apparatus according to claim 1, further comprising buffer members surrounding and accommodating the connecting support rods.

4. The sporting apparatus according to claim 1, wherein the support body includes a neck support supporting the neck of the user and a headrest on which the head of the user is seated, with the width of the support body increasing from the neck support to the headrest.

5. The sporting apparatus according to claim 4, wherein the neck support has a plurality of acupressure protrusions on an inner surface to press the neck of the user.
